(19) United States
(12) Patent Application Publication
(10) Pub. No.: US 2001/0049021 A1
(43) Pub. Date: Dec. 6, 2001

(54) Methods of improving bonding strength in primer/sealant adhesive systems

(76) Inventor: James L. Valimont, Cheswick, PA (US)

Correspondence Address: PPG INDUSTRIES INC, INTELLECTUAL PROPERTY DEPT, ONE PPG PLACE, PITTSBURGH, PA, 15272, US

(21) Appl. No.: 09/825,060

(22) Filed: Apr. 3, 2001

Related U.S. Application Data
(60) Provisional application No. 60/195,711, filed on Apr. 7, 2000.

(51) Int. Cl. C09J 1/00

(52) U.S. Cl. 428/423.1; 428/429; 156/327

(57) ABSTRACT

The present invention is directed to method of enhancing the adhesion characteristics of a primer/sealant adhesive system and the adhesive system. The method involves adding an acid material to the primer composition, which is at least one coupling agent. The acid material can be acetic acid, carboxylic acids, and other acid systems selected from sulfuric, nitric, phosphoric, or hydrochloric acid systems adjusted to have normalities as an acid with a pKa of about 4.75. The acid material can be present in the primer composition in an amount of about 0.1 to about 10 weight percent based on the total weight of the primer composition. After the initial primer composition is dried or cured on a substrate, a black out or secondary primer and/or a conventional sealant or adhesive composition is applied in any usual manner over the dried initial primer composition to bond the substrate. The resulting adhesive system has the primer composition comprising at least one acid material, and an adhesive composition. The adhesive system can be applied to a substrate having a ceramic coating, where the primer is applied over the ceramic coating, and an attachment can be connected to the adhesive.

### CROSS-REFERENCE TO RELATED APPLICATION

This application claims the benefits of U.S. Provisional Application No. 60/195,711, filed Apr. 7, 2000, entitled “METHODS OF IMPROVING BONDING STRENGTH IN PRIMER/SEALANT ADHESIVE SYSTEMS”, which is herein incorporated by reference.

### 1. FIELD OF THE INVENTION

This invention relates generally to adhesive systems and, more particularly, to methods of improving the bonding or adhesion strength of a primer/sealant adhesive system.

### 2. TECHNICAL CONSIDERATIONS

Adhesive bonding systems are used in many industrial applications. For example, in the automotive industry, adhesive bonding systems are used to adhere attachments, such as hinges, latches, door clips, sashes, locators, etc., onto automotive transparencies, such as windshields, sidelights, rear lights, moon roofs, sunroofs, etc. Adhesives may also be used to bond an automotive transparency to an opening in a vehicle body.

The adhesives used for such applications typically include polyurethane sealant compositions having one or more urethane pre-polymers and are used with one or more primer compositions. The primer compositions may include a solution of one or more silanes, and are applied to the glass prior to the application of the sealant composition to improve the adhesion strength of the attachment to the glass.

Primer/sealant adhesive systems are commercially available and generally provide adequate adhesion characteristics for automotive assembly operations. However, the adhesive strength of the cured or dried adhesive system may be adversely impacted by the ambient environmental conditions, such as the relative humidity, during application of the primer and/or sealant compositions.

Therefore, it would be desirable to provide an adhesive system, particularly a primer/sealant adhesive system, which is less affected by environmental conditions during application.

### SUMMARY OF THE INVENTION

The present invention provides a method of enhancing the adhesion characteristics of a primer/sealant adhesive system when applied over varying relative humidity conditions and includes adding an acidic material to the primer composition, e.g., an initial primer composition, of the adhesive system before application of the primer composition onto a substrate. In a preferred embodiment, the acidic material is glacial acetic acid and is added to a level of about 0.1 weight percent to about 5 weight percent, preferably about 0.5 weight percent, of the primer composition. After the initial primer composition is dried or cured, a black out or secondary primer and/or a conventional sealant or adhesive composition is applied in any usual manner over the dried initial primer composition to bond the substrate, e.g., an automotive transparency, to another substrate, e.g., an attachment.

### DESCRIPTION OF THE INVENTION

Unless otherwise indicated, all numbers expressing quantities of ingredients, reaction conditions, and so forth used in the specification and claims are to be understood as being modified in all instances by the term “about”. Additionally, any numeric reference to amounts, unless otherwise specified, is “by weight”; for instance, the phrase “solids of 34%” means “solids of 34% by weight”. The following United States Patents and patent application are herein incorporated by reference: U.S. Pat. Nos. 4,839,122; 4,761,916; 5,623,044; and 09/364,644.

The present invention is particularly useful in adhesive systems including a coupling agent, e.g., a primer composition, and a sealant or adhesive composition for bonding a first substrate, such as a glass or ceramic substrate, to a second substrate, such as a glass, ceramic, plastic, or metal substrate, e.g., an attachment item such as a hinge, latch, door clip, sash or locator.

Conventional primer compositions are commercially available from several sources, such as Dow Corning, Dow Automotive, Inc. (formerly Essex Special Products), General Electric, Lord Corporation, Ashland Chemical Corporation, Sika Corporation, Henkel Teroson, Morton Yokohama, Eftech, and Dinol, just to name a few. Some commercially available primers may include one or more organosilanes having various functionalities, such as, for example, amino, acrylic, or epoxy functionalities on one end and methoxy, ethoxy or chlorine functionalities on the other end, just to name a few. The primer compositions may be polyurethane-containing and/or automotive aqueous-borne or solvent-borne clearcoat compositions. Examples of silane containing primer compositions include diamino-tri-methoxy silanes commercially available under the designations Lord Chemlok AP-134 and Chemlok 144 or adhesion promoters, such as described in U.S. Pat. Nos. 4,839,122 and 4,761,916. Other useful commercial primer materials include “Betaseal® glass primers 435.18, 435.20A, and 435.21”, commercially available from Dow Automotive, Inc., of Auburn Hills, Mich. Additional adhesion primers include polyurethane compositions of U.S. Pat. No. 5,623,044 comprising (1) a urethane pre-polymer having an isocyanate functionality of at least about 2.0 and a molecular weight of at least about 2000; and (2) the reaction product of a secondary amino or mercapto alkoxy silane and a polyisocyanate having an average of at least one silane group in at least one isocyanate group per molecule and a molecular weight of less than about 2000. Other silane compound forms may also be suitable for primer compositions. For example, adhesion primers comprising organo-titanates or zirconium coupling agents are available from Kenrich Petrochemical, Inc. of Bayon, N.J. Generally, these coupling agents have moieties for reaction with organic compounds and moieties for reaction with inorganic materials.

In conventional adhesive systems, a primer composition is applied to the glass substrate and then cured or dried, such as by heating or by flash drying in ambient conditions. After the primer composition has dried to form a primer coating, a conventional adhesive composition, such as a polyurethane composition, is applied on top of the primer coating. An example of one such adhesive is Ashland Pliogrip® 8000 adhesive commercially available from Ashland Chemical Corporation. The attachment item may then be contacted to the adhesive and the adhesive system dried or cured in accordance with manufacturer's instructions to bond the attachment to the glass.

In the practice of the invention, an acid material is added to a conventional primer composition to affect, change or improve the adhesion characteristics of the resulting dried adhesive system. In a preferred embodiment, the acid material is glacial acetic acid commercially available from Fisher Scientific Company and is added to the primer composition to a level of about 0.1 weight percent to about 10 weight percent, preferably about 0.1 to about 5 weight percent, more preferably less than 1.0 weight percent, and most preferably about 0.5 weight percent based on the total weight of the primer composition. However, it should be appreciated that the invention is not limited to acetic acid. It is believed that other acids, such as carboxylic acids or weak acids of similar chemical characteristics, e.g., having a pKa of about 4.75, could also be used in the practice of the invention. Additionally, other acid systems, such as sulfuric, nitric, phosphoric, or hydrochloric acid systems, adjusted to similar normalities as the acetic acid system described above, may also be used, depending upon the particular commercial primer. Acids which may scratch or etch glass surfaces, such as HF, should preferably not be used. Further, the addition of acid material to levels above about 0.5 weight percent may adversely impact the shelf life of some conventional primer compositions by causing precipitation.

In the practice of the invention, the conventional primer composition with the added acid material (hereinafter “modified primer composition”), can be applied onto a glass or ceramic substrate in conventional manner, such as by brushing or spraying. The modified primer composition may then be cured in the same or similar manner as would the unmodified primer composition, such as by heating or ambient flash drying, to form a dried modified primer coating on the glass. The added acid material is not believed to adversely impact upon the typical drying or curing characteristics of the underlying primer composition to which it is added.

A conventional adhesive composition suitable for the particular primer composition used may then be applied in conventional manner onto the dried modified primer coating and the glass substrate adhered to another substrate, such as an attachment item, in conventional manner.

Illustrating the invention are the following examples which, however, are not to be considered as limiting the invention to their details.

### EXAMPLE 1

This Example illustrates the effect of adding acetic acid to a conventional primer composition on the resulting lap shear strength of the cured adhesive system.

Glacial acetic acid, commercially available from Fisher Scientific Company, was added to Chemlok 144 primer commercially available from Lord Corporation to a level of about 0.5 weight percent acetic acid to form a modified primer composition of the invention. This modified primer composition (modified Chemlok 144) was applied by a felt wiper and in accordance with manufacturer's instructions onto 5 mm thick, one inch x four inch tempered glass coupons having a layer of 0.001 inch thick enamel (commercially available from Cerdec, Inc.) under the various humidity and temperature conditions set forth in Table 1 below. The enamel coated glass coupons coated with the modified primer composition were dried in ambient air for about 1-5 minutes to form a dried modified primer coating film having a thickness of about 1.5 microns to about 2.5 microns on the ceramic coated glass coupons.

Ashland Pliogrip® 8000 adhesive was then applied onto the dried modified primer coating in a bead large enough to cover the overlap shear area. Then, a coupon of electrocoated steel (commercially available from Act Laboratories) was placed onto the adhesive bead and supported to form an overlap shear test sample with an overlap area of about 0.25 square inch. The adhesive system was then cured by ambient air drying and the lap shear strength of the adhered enamel coated glass and steel coupons was determined by pulling the adhered coupons apart. Control coupons using conventional, i.e. unmodified Chemlok 144 primer composition, were also evaluated under the same temperature and humidity conditions.

Table 1 below shows the average lap shear strength values (psi) for three sets of adhesive systems (with and without the added acid material) tested at each temperature and humidity condition listed. The Failure Modes are (1) “CO” meaning that the adhesive system split, and/or (2) A1 meaning that the primer/adhesive system pulled off of the enamel coated surface.

TABLE 1

| Humidity/ | | | Average | Failure |
|---|---|---|---|---|
| Temp. | Glass Primer | Exposure | (psi) | Mode |
| 45%/71° F. | Modified Chemlok 144 | Rm. Temp. | 1024 | CO |
| 45%/71° F. | Chemlok 144 | Rm. Temp. | 1064 | CO |
| 51%/70° F. | Modified Chemlok 144 | Rm. Temp. | 1253 | CO |
| 51%/70° F. | Chemlok 144 | Rm. Temp. | 876 | CO |
| 59%/70° F. | Modified Chemlok 144 | Rm. Temp. | 1281 | CO |
| 59%/70° F. | Chemlok 144 | Rm. Temp. | 947 | CO |

The adhesive system utilizing the modified primer composition of the invention showed approximately equivalent shear strength at 45% relative humidity but improved shear strength at higher relative humidities with respect to the conventional (non-modified) adhesive system. It should be noted that, as shown in the Tables below, improved performance at 45% relative humidity was observed for other modified primer systems.

Table 2 below shows the results of lap shear strength tests for similarly bonded coupons after the adhered coupons were immersed in a room temperature water bath for 2 or 3 weeks, respectively. In each system tested, the adhesive system having the modified primer composition showed improved lap shear strength over the conventional system without the modified primer composition.

TABLE 2

| Humidity/ | | | Average | Failure |
|---|---|---|---|---|
| Temp. | Glass Primer | Exposure | (psi) | Mode |
| 45%/71° F. | Modified Chemlok 144 | 2 wks Imm. | 1237 | CO |
| 45%/71° F. | Chemlok 144 | 2 wks Imm. | 544 | Al |
| 51%/70° F. | Modified Chemlok 144 | 2 wks Imm. | 1436 | CO |
| 51%/70° F. | Chemlok 144 | 2 wks Imm. | 1225 | Al/CO |
| 59%/70° F. | Modified Chemlok 144 | 2 wks Imm. | 1008 | CO |
| 59%/70° F. | Chemlok 144 | 2 wks Imm. | 658 | Al/CO |
| 45%/71° F. | Modified Chemlok 144 | 3 wks Imm. | 1117 | CO |
| 45%/71° F. | Chemlok 144 | 3 wks Imm. | 586 | Al |
| 51%/70° F. | Modified Chemlok 144 | 3 wks Imm. | 927 | CO |
| 51%/70° F. | Chemlok 144 | 3 wks Imm. | 840 | Al/CO |
| 59%/70° F. | Modified Chemlok 144 | 3 wks Imm. | 1270 | CO |
| 59%/70° F. | Chemlok 144 | 3 wks Imm. | 145 | Al |

Table 3 shows the lap shear strength measurements for adhered coupons (prepared as described above) after 2 or 3 weeks immersion in a one normal sulfuric acid aqueous bath. Again, the adhesive systems utilizing the modified primer composition of the invention generally show improved lap shear strength compared to the conventional systems over the range of relative humidities tested.

TABLE 3

| Humidity/ | | | Average | Failure |
|---|---|---|---|---|
| Temp. | Glass Primer | Exposure | (psi) | Mode |
| 45%/71° F. | Modified Chemlok 144 | 2 wks | 1535 | CO |
| | | acid Imm. | | |
| 45%/71° F. | Chemlok 144 | 2 wks | 541 | Al |
| | | acid Imm. | | |
| 51%/70° F. | Modified Chemlok 144 | 2 wks | 1199 | CO |
| | | acid Imm. | | |
| 51%/70° F. | Chemlok 144 | 2 wks | 1027 | Al/CO |
| | | acid Imm. | | |
| 59%/70° F. | Modified Chemlok 144 | 2 wks | 1448 | CO |
| | | acid Imm. | | |
| 59%/70° F. | Chemlok 144 | 2 wks | 799 | CO/Al |
| | | acid Imm. | | |
| 45%/71° F. | Modified Chemlok 144 | 3 wks | 1128 | CO |
| | | acid Imm. | | |
| 45%/71° F. | Chemlok 144 | 3 wks | 681 | Al |
| | | acid Imm. | | |
| 51%/70° F. | Modified Chemlok 144 | 3 wks | 954 | CO |
| | | acid Imm. | | |
| 51%/70° F. | Chemlok 144 | 3 wks | 1200 | Al |
| | | acid Imm. | | |
| 59%/70° F. | Modified Chemlok 144 | 3 wks | 1114 | CO |
| | | acid Imm. | | |
| 59%/70° F. | Chemlok 144 | 3 wks | 424 | Al/CO |
| | | acid Imm. | | |

### EXAMPLE 2

Bonded ceramic coated glass coupon and metal coupon pairs, with either modified and unmodified primer compositions, were prepared as described above in Example 1 using other commercially available primers. The modified primers included glacial acetic acid (AA) at a level of about 0.5 weight percent. The coupon pairs were immersed in a room temperature water bath for two weeks and then the lap shear strength was determined as described above. The results are shown in Table 4 below.

For the “Failure Modes” listed in Table 4, A1 means the primer/adhesive system pulled off of the enamel coated glass surface; CO means the adhesive system split; B1 means the glass broke; and CP1 means the primer split.

TABLE 4

| | | | Average | Failure |
|---|---|---|---|---|
| Group | Glass Primer | Humidity | (psi) | Mode |
| I | Glassgrip 7780¹ | 25% | 438 | Al/Bl |
| | Glassgrip 7780 | 75% | 540 | Al/Bl |
| | Glassgrip 7780 + .5% AA | 25% | 628 | Al/Bl |
| | Glassgrip 7780 + .5% AA | 75% | 714 | Al/CO |
| II | Betawipe VP 4604² | 25% | 857 | Bl |
| | Betawipe VP 4604 | 75% | 740 | Bl/CO/Al |
| | Betawipe VP 4604 + .5% AA | 25% | 1444 | Bl/CO |
| | Betawipe VP 4604 + .5% AA | 75% | 953 | Bl/CO/Al |
| III | Betaseal 435.18³ | 25% | 1148 | Bl/CO |
| | Betaseal 435.18 | 75% | 249 | Al/CO |
| | Betaseal 435.18 + .5% AA | 25% | 953 | CO/Bl |
| | Betaseal 435.18 + .5% AA | 75% | 999 | Bl/Al/CO |
| IV | Sika Activator⁴ | 25% | 1173 | Bl |
| | Sika Activator | 75% | 643 | CO/Al/Bl |
| | Sika Activator + .5% AA | 25% | 1362 | Bl/CO |
| | Sika Activator + .5% AA | 75% | 785 | Bl/Al |
| V | Terostat 8518⁵ | 25% | 587 | Al |
| | Terostat 8518 | 75% | 252 | Al/CPl |
| | Terostat 8518 + .5% AA | 25% | 448 | Al/CPl |
| | Terostat 8518 + .5% AA | 75% | 511 | Al/CPl |
| VI | MS90⁶ | 25% | 390 | Al |
| | MS90 | 75% | 357 | Al |
| | MS90 + .5% AA | 25% | 297 | CPl/Al |
| | MS90 + .5% AA | 75% | 565 | Al |
| VII | W002/6462⁷ | 25% | 1099 | BlAl/CO |
| | W002/6462 | 75% | 987 | Bl/CO |
| | W002/6462 + .5% AA | 25% | 718 | Bl |
| | W002/6462 + .5% AA | 75% | 1013 | CO/Bl |
| VIII | PUR520⁸ | 25% | 1187 | Bl/Al |
| | PUR520 | 75% | 1039 | Al/Bl |
| | PUR520 + .5% AA | 25% | 1117 | Bl |
| | PUR520 + .5% AA | 75% | 780 | Bl/Al |
| IX | Chemlok AP-133⁹ | 25% | 103 | Al |
| | Chemlok AP-133 | 75% | 154 | Al |
| | Chemlok AP-133 + .5% AA | 25% | 0 | Al |
| | Chemlok AP-133 + .5% AA | 75% | 282 | Al |
| X | Chemlok AP-134¹⁰ | 25% | 439 | Al/CO |
| | Chemlok AP-134 | 75% | 581 | Al/Bl |
| | Chemlok AP-134 + .5% AA | 25% | 1437 | CO/Bl |
| | Chemlok AP-134 + .5% AA | 75% | 1338 | CO/Bl |

1. Glassgrip 7780 primer commercially available from Ashland Chemical Corporation

2. Betawipe VP 4604 primer commercially available from Gurit Essex

3. Betaseal 435.18 primer commercially available from Dow Automotive, Inc.

4. Sika Activator primer commercially available from Sika Corporation

5. Terostat 8518 primer commercially available from Henkel Teroson

6. MS90 primer commercially available from Morton Yokohama

7. W002/6462 primer commercially available from Eftech

8. PUR520 primer commercially available from Dinol

9. Chemlok AP-133 primer commercially available from Lord Corporation

10. Chemlok AP-134 primer commercially available from Lord Corporation

For the modified Glassgrip 7780, Betawipe VP 4604, Betaseal 435.18 and Chemlok AP-134 primer systems, generally improved results were obtained. The modified Sika Activator, Terostat 8518, MS90, W002/6462, PUR520 and Chemlok AP-133 primer systems, however, showed approximately equivalent performance to the unmodified systems.

In addition to use with primer/sealant adhesion systems as described above, the present invention is also useful for improving adhesion for encapsulation. For example, Chemlok 144 is commonly used for priming glass for reaction injection molding (RIM) encapsulation. In this procedure, the Chemlok 144 functions as the adhesive for bonding the encapsulation to the glass. Following the manufacturer's instructions, the encapsulator must condition the primed glass to hydrolyze in moist air (50%-80% relative humidity) for one hour prior to molding. Modifying the Chemlok 144 with 0.5 weight percent acetic acid in accordance with the invention permits immediate bonding with equal or greater final adhesion even at relative humidities lower than 50%-80%.

It will be readily appreciated by those skilled in the art that modifications may be made to the invention without departing from the concepts disclosed in the foregoing description. For example, in the preferred embodiment of the invention described above, the acid material was added to the primer composition of a two component primer/sealant system. It is believed that the invention could also be practiced on single component sealant or adhesive systems. Accordingly, the particular embodiments described in detail herein are illustrative only and are not limiting to the scope of the invention, which is to be given the full breadth of the appended claims and any and all equivalents thereof.

What is claimed is:

1. A method of improving the bond strength of an adhesive system comprising at least one coupling agent, the method comprising adding an acid material to the coupling agent.

2. The method according to claim 1, wherein the coupling agent is a primer composition.

3. The method according to claim 1, wherein the primer composition is a solution of one or more silanes.

4. The method according to claim 2, wherein the acid material comprises an acid having a having a pKa of about 4.75.

5. The method according to claim 2, wherein the acid comprises about 0.1 to about 10 weight percent of the primer composition.

6. The method according to claim 1, wherein the acid material is selected from the group of acetic acid, carboxylic acids, and other acid systems selected from sulfuric, nitric, phosphoric, or hydrochloric acid systems adjusted to have normalities as an acid with a pKa of about 4.75.

7. The method according to claim 1, wherein the acid material is comprises acetic acid.

8. The method according to claim 7, wherein the acetic acid is glacial acetic acid which comprises about 0.1 to about 5 weight percent of the primer composition based on the total weight of the primer composition.

9. The method according to claim 7, wherein the acetic acid comprises less than 1.0 weight percent of the primer composition based on the total weight of the primer composition.

10. The method according to claim 8, wherein the acetic acid comprises about 0.5 weight percent of the primer composition.

11. An adhesive system, comprising:
a primer composition comprising at least one acid material; and
an adhesive composition.

12. The system according to claim 11, wherein the primer composition is a coupling agent.

13. The system according to claim 11, wherein the primer composition is a solution of one or more silanes.

14. The system according to claim 11, wherein the acid material comprises an acid having a having a pKa of about 4.75.

15. The system according to claim 11, wherein the acid comprises about 0.1 to about 10 weight percent of the primer composition.

16. The system according to claim 15, wherein the acid material comprises acetic acid.

17. The system according to claim 16, wherein the acetic acid is glacial acetic acid which comprises about 0.1 to about 5 weight percent of the primer composition based on the total weight of the primer composition.

18. The system according to claim 16, wherein the acetic acid comprises less than 1.0 weight percent of the primer composition based on the total weight of the primer composition.

19. The system according to claim 16, wherein the acetic acid comprises about 0.5 weight percent of the primer composition.

20. The system according to claim 11, wherein the adhesive composition includes polyurethane sealant compositions having one or more urethane pre-polymers.

21. A method of bonding a first substrate to a second substrate, comprising the steps of:
applying a primer composition to the first substrate, the primer composition comprising at least one acid additive material;
applying an adhesive composition over the primer composition; and
contacting the second substrate with the adhesive material.

22. An article, comprising:
a substrate having a ceramic coating;
a primer coating applied over the ceramic coating, the primer coating formed from a primer composition having an acid additive;
an adhesive applied over the primer coating;
and
an attachment connected to the adhesive.

23. The article of claim 22 which is an automotive transparency.
